(19) United States
(12) Patent Application Publication
(10) Pub. No.: US 2026/0249405 A1
(43) Pub. Date: Aug. 27, 2026

(54) METHOD AND DEVICE FROM INTRODUCING A JOINING ELEMENT INTO AT LEAST ONE COMPONENT

(71) Applicant: STÖGER AUTOMATION GMBH, Königsdorf (DE)

(72) Inventor: Thomas Fischhaber, Lenggries (DE)

(21) Appl. No.: 18/872,557

(22) PCT Filed: Jun. 7, 2023
(86) PCT No.: PCT/EP2023/065307

§ 371 Date: Dec. 7, 2024

(30) Foreign Application Priority Data
Jun. 8, 2022 (DE) 10 2022 114 425.9

(51) Int. Cl. B23P 19/06; B23Q 17/00

(52) U.S. Cl. CPC B23P 19/06; B23Q 17/00

(57) ABSTRACT

The invention relates to a method for introducing a joining element (10) into at least one component (11) along a joining axis (14) using a joining tool (30, 130) which is designed to guide the joining element (10) in the direction of the joining axis (14). The invention additionally relates to a device (20) for introducing a joining element (10) into a component, having a receiving device (31, 131), on which the joining element (10) can be received, and a drive device (32, 132) for guiding the joining element (10) into the component (11).

The present invention relates to a method for inserting a joining element into at least one component along a joining axis by means of a joining tool which is designed to guide the joining element in the direction of the joining axis.

In joining technology in particular, the requirements for process reliability, process control and process monitoring are increasing. In order to meet the increasing requirements, joining technology devices, such as devices for introducing joining elements into components, are equipped with a variety of sensors to actively control processes and monitor and in particular visualize process variables such as speed, torque, axial force, transverse force, bending loads and temperatures.

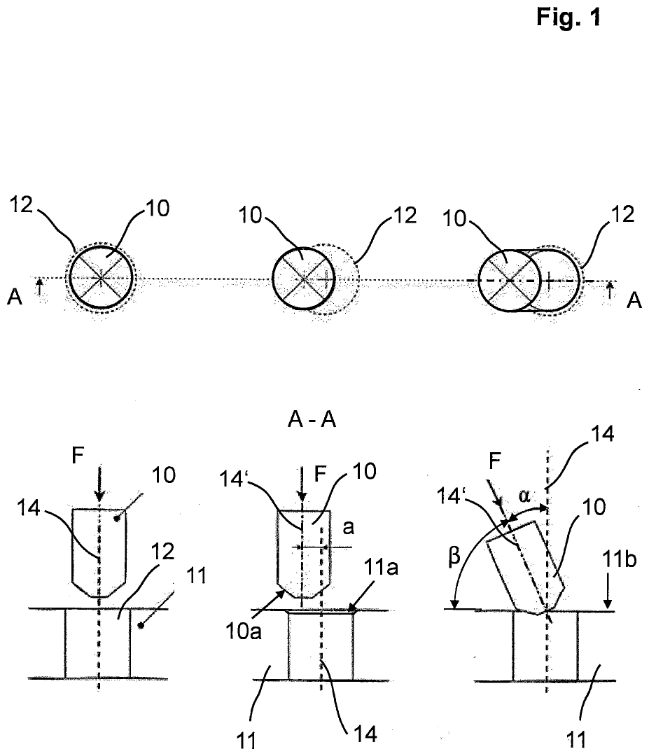

In a large number of joining processes, a force is applied along a joining axis on the components and/or joining elements to be joined. In an optimal joining process, the force or connection axis and the component surface normal or target bore axis coincide at every process time. Deviations with regard to coincidence are, for example, tilting along a transverse axis (angular offset) or a parallel axis displacement (axis offset). In FIG. 1, such deviations are shown in comparison to an ideal case. Possible consequences of a deviation are, in particular, increased loads on the joining device, the joining element and the joining parts, a misalignment of the joining element, failure to reach the head support, increased process variables during joint production, failure to reach the target values of the produced joint, insufficient tightness of the joint and/or increased energy and heat input.

If a joining element leaves the target position during introduction into at least one pre-drilled component, the joining axis aligns with the bore axis, which leads to deflection of the joining tool and to transverse loading of the entire system. If a joining element leaves the target position during introduction into at least one pre-drilled component, the joining axis aligns with the surface normal when the head support is reached, which leads to stress or damage to the joining tool, the joining element and the joining parts.

Particularly in the area of flow-hole forming bolting (see bulletin DVS/EFB 3445-1), such phenomena lead to known quality defects due to the high process forces. The cause of this problem lies in the unique features of this type of screw connection. Flow drilling screwing differs from other known joining processes in key aspects. For example, a combination of one-sided accessibility and thus a lack of possibility for counter-holding as well as high joining forces leads to temporary or partly permanent misalignment of joining elements in the joining process.

Previously known measures for improving this joining process have not yet led to a satisfactory solution for detecting deviations from the joining axis, and in particular misalignment of the fasteners during and after the process, and ensuring the quality of the joint on this basis. Previously known measures include the deliberate incorrect positioning of the screw axis before the process, a reduction in process performance and/or downstream destructive quality assurance in the form of macrosections.

Based on this the object of the invention is to provide an improved method for introducing a joining element into at least one component as well as to provide an improved device and an improved joining tool for introducing a joining element into at least one component.

According to the invention, this is achieved by the teaching of the independent claims. Further and preferable embodiments of the invention are subject of the dependent claims.

As a solution to the object of the invention, a method for introducing a joining element into at least one component along a joining axis is proposed in a first aspect, by means of a joining tool, by means of a joining tool which is designed to guide the joining element in the direction of the joining axis. The method comprising the following steps:
a) Receiving the joining element on the joining tool;
b) Positioning the joining tool with the joining element on the component;
c) Guiding the joining element into the component, wherein
   c1) on the joining tool, data of at least one process variable characterizing the load of a joining element guided into the component are recorded and sent to a machine control;
   c2) the machine control determines a load on the joining element and, from this, a possible deviation of the load on the joining element from a target load with the aid of the data obtained for the at least one process variable, thereby enabling a non-destructive evaluation of the joint quality during and after the joining element is guided into the component; and
d) Releasing the joining tool from the joining element as soon as the joining element has been introduced into the component.

The proposed method for introducing a joining element into at least one component along a connection axis is, in particular, a joining method in which joining elements such as screws, rivets, bolts and the like are introduced into at least one component. The method includes all types of joining elements that are introduced into a component along a joining axis, regardless of whether they are single-part or multi-part. The method is particularly suitable for flow-hole-forming screwing. Furthermore, the proposed method relates to an introduction of such a joining element into at least one component, for example to connect the joining element to one or more components and/or to connect two or more components to one another by means of the at least one joining element. Accordingly, the further description always relates to all such cases.

The at least one component can have a component design intended for joining with a joining element, in particular a component design prepared for this purpose, such as an opening or recess. Likewise, the component at the joining position can have no special design intended for the joining process, whereby such a design can be formed during the joining process. The joining tool is designed to guide the joining element in the direction of the joining axis, in particular under axial force, and to introduce the joining element into the at least one component. During the movement of the joining element in the direction of the connection axis, a rotational movement can also be provided at least temporarily, whereby the joining element is, for example, turned in, in particular screwed, into the component. In a particular embodiment, the joining tool is designed to be arranged on a robot station.

In a first step a), the joining element is received on the joining tool. In particular, the joining tool has a receiving device for this purpose, which is arranged in particular at its axial end and on which the at least one joining element can be received in particular in a form-fit manner. Of course, it is also possible for the joining element to be received in particular additionally by force on the receiving device, for example by magnetic or inductive force.

In a second step b), the joining tool with the joining element is positioned on the component. In particular, the joining element is positioned at its axial end facing the component at the position of the at least one component at which the joining element is to be introduced into the component, in particular along the joining axis. Furthermore, the joining tool with the joining element is positioned relative to the component in such a way that the joining element is aligned in accordance with the intended joining axis. In particular, the joining axis is arranged in coincidence, i.e. in line with a component surface normal. In particular, the positioning of the joining element is concentric to a target or connecting hole or opening provided on the at least one component.

In a third step c), the joining element is guided into the at least one component and thus introduced, wherein in a partial step c1), data of at least one process variable characterizing the load or the load state of the joining element guided into the component are recorded on or in particular directly in the joining tool, in particular during the entire or a part of the introduction process of the joining element into the component, and sent to a machine control. This data is recorded in particular by means of suitable sensors, which can be arranged on the joining tool or integrated with the joining tool, for example. In particular, this involves data from process variables acting on the joining tool, such as rotational speed, torque, axial force, transverse force, bending load, acceleration and/or temperature, whereby these process variables can be recorded both by sensors provided for this purpose and by other devices involved in the introduction of a joining element, such as drives in particular.

In a further sub-step c2), a in particular a computing device of the machine control determines a load on the joining element and from this a possible deviation of the load on the joining element from a target load or a target load state with the aid of the data received, in particular recorded on and/or in the joining tool. In particular, this enables a non-destructive evaluation of the joint quality while the joining element is being guided into the component and also using the recorded data after the joining element has been guided into the component. A target load of a joining element is defined in particular by data of process variables or a relation of such process variables that can be recorded on the joining tool during a planned joining process. A deviation from the target load or a target load state exists in particular if a value or a relation of several values of one or more process variables, in particular those recorded on the joining tool, exceeds or falls below a predetermined target value or the value of the target value is not within a specified range. The knowledge of a certain deviation from the target load during the guiding of the joining element into the component, in particular a value of the deviation in connection with the target variable or one or more relations thereto, allows an evaluation of the quality of the process of guiding or introducing the joining element into the at least one component and thus also of the quality of a manufactured connection, in particular between the joining element and the component or between two components by means of the joining element.

In a fourth step d), the joining tool is released from the joining element as soon as the joining element has been introduced into the component. At this point, the connection is established and the process of guiding or introducing the joining element into the at least one component is completed accordingly.

The proposed method enables the determination of a deviation of at least one process variable characterizing the load of a joining element from a target process already during the introduction of the joining element into a component. On the basis of the determined deviation, it is possible to improve the introduction process and thus the quality of the joints produced. Furthermore, a missing deviation or a deviation within specified tolerance values can serve as proof of the quality of the manufactured joint.

In one embodiment of the method for introducing a joining element into at least one component, the machine control also determines the possible deviation of the positioning of the joining tool from a target positioning in step c2). The deviation can, for example, be designed as an axial or angular offset or as a combined offset with portions of these types of offset in particular. In this way, the proposed method also allows to determine a deviation in the positioning of a joining element from a target positioning during the introduction of the joining element into a component.

In one embodiment of the method for introducing a joining element, the machine control system derives at least one correction value for at least one process variable in a further step c3) in the event of a specific deviation, in particular of the load on the joining element or the positioning of the joining tool. The at least one correction value for the at least one process variable characterizing the deviation can be derived in particular from at least one value characterizing the deviation, in particular in conjunction with at least one target variable of the process variable or, for example, a relation of several target variables of one or more process variables recorded in particular on the joining tool. The at least one derived correction value can, for example, be used as a basis for improving a joining process that is still running at the time of the detected deviation and/or a later joining process.

If the determined deviation and thus the at least one derived correction value relates to the positioning of the joining tool relative to the component, this can be derived from at least one process variable characterizing the deviation, in particular in conjunction with at least one target variable of a position or, for example, a relation of several target variables of one or more process variables recorded in particular on the joining tool. The at least one derived correction value can be used in particular as a basis for correcting the load or the positioning of the joining tool or the joining element of a joining process that is still running at the time of the detected deviation and/or of a later joining process.

In one embodiment of the method for introducing a joining element, the at least one process variable is corrected in a further step c4) using the at least one correction value derived in step c3) for the at least one process variable. The correction of the at least one process variable can take place while a joining element is still being introduced into a component, thereby increasing the quality of the currently produced joint. The correction of the at least one process variable can also be used to improve the process. In this case, the correction of the at least one process variable takes place after completion of the current introduction process and comes into effect during a subsequent execution of the process for introducing a joining element into a component so that, for example, continuous process improvement is made possible. The correction of the at least one process variable can also be carried out repeatedly, in particular after a deviation has been determined and a correction value has been derived during the teach-in process of the method for introducing a joining element in a device intended for the application of the method.

In one embodiment of the method for introducing a joining element, the joining tool can be positioned relative to the component by means of the positioning device both in a plane perpendicular to the joining axis and at at least one angle to a component surface and thus also at an angle to the original joining axis. In particular, the joining tool can be positioned spatially freely relative to the component or the component surface by means of the positioning device. In this embodiment, the positioning device can correct the positioning of the joining tool relative to the component in step c4) based on the at least one derived correction value. The correction of the positioning of the joining tool and thus also of the joining element can take place before or after and/or during the introduction of the joining element into the component. The positioning can be corrected both in a plane perpendicular to the joining axis and at least at an angle to a component surface and, in particular, spatially free in relation to the component or the component surface or the original joining axis. In particular, the positioning is corrected in such a way that the detected deviation is compensated for, or at least partially overcompensated for, depending on the type of deviation. This makes it possible to significantly improve the quality of a manufactured joint both during and after the joining process.

In one embodiment of the method for introducing a joining element, the at least one correction value derived in step c3) is used in a further step e) for the positioning of the joining tool during the execution of step b), the positioning of the joining tool with the joining element on the component. In particular, step e) is carried out during a subsequent joining process and during a subsequent execution of the method for introducing a joining element. In this way, it is possible to improve the proposed method during repeated execution, particularly with regard to the quality of the joints produced. This process step can be used particularly advantageously during the teach-in process of a process for introducing a joining element.

In one embodiment of the method for introducing a joining element, the data of the at least one process variable recorded on the joining tool in step c1) are suitable for determining a transverse force acting on the joining tool and/or on the joining element. The transverse force acting on the joining tool during the joining process is suitable as a parameter for the component load and thus for monitoring the quality of the joint produced. In particular, its value also represents a measure for a possible deviation of the positioning of the joining tool from its target positioning. Thus, by monitoring the transverse force during the introduction of a joining element, a possible deviation of the component load from the target load can be determined and at least one correction value for the process variables during the introduction of the joining element into the component can be derived. In addition, the transverse force is also a parameter that can be used to determine a deviation in the positioning of the joining tool and to derive at least one correction value for the positioning of the joining tool. A transverse force acting on the component and thus also on the joining element or joining tool results in a tilting moment at at least one bearing point of the joining tool. Based on an analysis of component stiffnesses of the elements of the device used for the joining process, it is possible to monitor and/or prevent pressure ellipse separation in rolling element bearings of the joining tool and/or other components in conjunction with the transverse force recorded in the process.

In a second aspect, a device for introducing a joining element into at least one component along a joining axis is proposed as solution to the object. For introducing the joining element, the device has a joining tool which is designed to guide the joining element in the direction of the joining axis. The joining tool has a receiving device on which a joining element can be received on the joining tool and a drive device for guiding the joining element into the component. A sensor device for recording related data of at least one process variable characterizing the load on a joining element guided into the component is arranged on or directly in the joining tool of the device. Furthermore, the device has a machine control which is arranged to determine a possible deviation of the load on the joining element from a target load using the recorded data of the at least one process variable.

The proposed device is particularly suitable for carrying out one or more steps of the previously proposed method for introducing a joining element into at least one component. In particular, the device enables a non-destructive evaluation of the joint quality during and after introduction of the joining element into the component. Aspects of the method which influence the design of elements of the device or the elements to be joined and their relationship to one another are to be understood in the same way as in the preceding description and are therefore not explained separately in connection with the proposed device.

The joining tool of the device is designed to guide the joining element in the direction of the joining axis, in particular under axial force, and thereby introduce the joining element into the at least one component. To receive a joining element, the joining tool has a receiving device arranged for this purpose, in particular at its axial end facing the component, on which the at least one joining element can be received, in particular in a form-fitting manner. Furthermore, the receiving device can also be designed in such a way that a joining element can also be received on the receiving device in addition to a positive fit at least partially by a force fit, for example by means of magnetic or inductive force.

The joining tool has a drive device, or is connected to a drive device, in order to guide a joining element received on the receiving device, in particular by applying force and in particular in a longitudinal movement in the direction of the joining axis. The drive device can also be arranged to drive the joining element in rotation at least temporarily, in particular in addition to axial loading, whereby the joining element is for example turned in, in particular screwed into the component.

A sensor device for recording data of at least one process variable characterizing the load on an adjacent joining element is arranged on or directly in the joining tool of the proposed device. In this context, “arranged on the joining tool” is to be understood as meaning that the at least one sensor device is provided on the device in such a way that process variables acting on the joining tool can be recorded by means of it. Accordingly, the sensor device can, for example, be designed directly on the joining tool itself, in close proximity to it or integrated with the joining tool. Directly arranged in the joining tool is understood to mean, for example, mounting a sensor device in a bore or groove of an element of the joining tool that transmits the force flow when a joining element is introduced. The sensor device can have one or more sensors or sensor elements arranged on the joining tool in such a way that one or more process variables can be recorded by means of the one or more sensor elements. In particular, the sensor elements are designed in such a way that they use one or more physical effects to record the at least one process variable.

Furthermore, the device has at least one machine control which is arranged to determine a possible deviation from the target load using the recorded data of the at least one process variable. As already explained, a target load defines in particular a process variable that can be recorded on the joining tool or a relation of such process variables during a planned joining process. A deviation from the target load exists in particular if a value or a relation of values of one or more process variables, in particular those recorded on the joining tool, exceeds or falls below a predetermined target value. The knowledge of a certain deviation from the target load, in particular a value of the deviation in connection with the target load during the guiding of the joining element into the component, in particular a value of the deviation in connection with the target variable or one or more relations thereto, allows a particularly non-destructive evaluation of the connection quality of the process of guiding or introducing the joining element into the at least one component and thus also of the quality of the connection produced, in particular between the joining element and the component or between two components by means of the joining element.

The proposed device enables the determination of a deviation of the load on the joining element by means of recorded data of at least one process variable, in particular during the guiding or introduction of a joining element into a component. Based on a determined deviation of the load on the joining element from a target load, a particularly non-destructive evaluation of the joint quality during and after guiding the joining element into the component is possible. This also allows to adapt the target process of the device in such a way that the introduction process and thus the quality of joints produced with the device is improved. In addition, a lack of deviation in the load on the joining element or a deviation within specified tolerance values can provide evidence of the quality of the joint produced.

In one embodiment of the device, the machine control is arranged to determine a possible deviation of the actual position of the joining tool from a target position using the recorded data of the at least one process variable. The deviation can, for example, be an axial or angular offset or a combined offset, in particular with proportions of such types of offset. In particular, the device is designed so that a deviation of the actual position of a joining element from a target position can already be determined during the guiding or introduction of the joining element into a component.

One embodiment of the device has a positioning device for supporting and positioning the joining tool on the component. By means of the positioning device, the joining tool can be positioned relative to the component both in a plane perpendicular to the joining axis and at an angle to a component surface. In particular, the positioning device is arranged to position the joining tool freely in relation to the component or the component surface.

In one embodiment of the device, the positioning device is arranged to correct the positioning of the joining tool relative to the component. In particular, the positioning device is designed such that positioning or correction of the position of the joining tool or of a joining element arranged thereon can be carried out at least partially before, during and/or after introduction of the joining element into a component.

In one embodiment of the device, the sensor device is arranged to record at least one process variable which is selected from a group comprising the process variables rotational speed, torque, axial force, transverse force, bending load, acceleration and temperature. Of course, the group can include further process variables which can be recorded by means of the sensor device of the device and by means of which at least one process variable can be recorded, from the value of which, or in conjunction with the value of which or the value of at least one further process variable, a possible deviation of the component load from a target load and/or a possible deviation from a target positioning of a joining element can be determined.

In one embodiment of the device, the machine control is arranged to determine at least one reaction variable acting on the joining tool, such as the transverse force, the normal force and/or the torque, from the data of the at least one recorded process variable. The reaction variable used in each case can either be recorded directly or determined using a relationship between the values of at least two process variables. For example, a transverse force acting on the joining tool can be determined using a (bending) normal stress sensor element.

In a third aspect, a joining tool for introducing a joining element into at least one component along a joining axis is proposed as a solution of the object, which is designed to guide the joining element in the direction of the joining axis, wherein the joining tool has a receiving device on which the joining element can be received on the joining tool. The proposed joining tool has at least one sensor device for recording data of at least one process variable that can be recorded on the joining tool, which is designed integrally with the joining tool. In particular, the joining tool is designed to be used when carrying out the method described above, in particular also in conjunction with the device described above.

When a sensor device is designed integrally with the joining tool, the sensor device forms a functional unit with the joining tool. In particular, elements of the joining tool also serve to implement at least one function of the sensor device integrated with it, such as the transfer of temperatures or forces or deformations to measuring elements of the at least one sensor device or to shield the sensor elements from the environment.

Accordingly, the at least one sensor device of the joining tool, which is designed integrally with the joining tool, is arranged in particular to interact with at least one element of the joining tool in order to record the respective process variable(s). For this purpose, the sensor device can be arranged in a cavity formed inside the joining tool. For example, strain gauges arranged inside the joining tool and connected to a structural element of the joining tool can directly record forces acting during the joining process or resulting strains of the joining tool. Furthermore, movement sensors can be arranged inside the joining tool or at least partially formed by the joining tool, which record movements of the joining tool such as its rotational speed or its axial and/or rotational forces or accelerations. In the same way, a large number of further sensor elements, which are suitable for recording one or more process variables to determine a possible deviation from the target process, can be integrated with the joining tool.

In particular, the joining tool has a drive device or is connected to a drive device in order to guide a joining element received on the receiving device, in particular in a force actuated manner and in particular in a longitudinal movement in the direction of the connection axis. The drive device can also be designed to apply a rotational movement to the joining tool, in particular in order to drive the joining element at least temporarily in rotation during the movement of the joining element in the direction of the connection axis, so that the joining element can be turned in or screwed into the component by means of the joining tool.

To receive a joining element, the joining tool has a receiving device arranged in particular at its axial end facing the component, on which the at least one joining element can be held in particular in a form-fit manner. The receiving device can also be designed in such a way that a joining element can in particular in addition to a positive fit also be at least partially received on the receiving device in a non-positive manner, for example by means of magnetic or inductive force.

In order to record the process variables required to determine a deviation from a target process, a suitable design of the joining tool is required, particularly with regard to its geometry, material properties and geometric resistance. For this purpose, the joining tool must be adapted to the boundary conditions of the intended joining task, which in particular allows to record several measured variables at one position of the component.

The proposed joining tool makes it possible to determine a deviation of at least one process variable from a target process during the introduction of the joining element into a component. On the basis of the determined deviation, it is possible, in particular according to the proposed method, to record the component load during the introduction process and thus to evaluate the quality of manufactured joints and improve them on this basis. Furthermore, a missing deviation or a deviation within predetermined tolerance values of the component load can serve as proof of the quality of the manufactured joint. Features and properties of the proposed joining tool, in particular in connection with the introduction of a joining element into a component, are to be understood as essentially analogous to the above described device for introducing a joining element, in connection with which the embodiment of the joining tool described here can be used for introducing a joining element into a component. Aspects of the process and properties of the device which influence the design of elements of the device or the elements to be joined and their relationship to one another are to be understood in the same way as in the preceding description and are therefore not explained separately for this particular embodiment of the joining tool.

One embodiment of the joining tool has an interface for supplying energy and/or data to the at least one sensor device designed integrally with the joining tool. A preferred embodiment has a single such interface; however, in an embodiment in which an energy and/or data supply of at least one sensor device is not compatible with the energy and/or data supply of at least one further sensor device, at least one further interface may be required. The number of connection points required can be reduced, particularly for devices with a screwdriver stroke, in which the power supply and data transmission must be ensured over an axial range, thereby facilitating cable routing to and from the joining tool.

In one embodiment of the joining tool, the data transmission of at least one sensor device integrated with the joining tool takes place via a wireless connection. For example, the data is transmitted in particular over long distances via Bluetooth, WLAN, IWLAN or Li-Fi. This design is particularly advantageous when using so-called intelligent sensor devices.

In one embodiment of the joining tool, the energy supply for at least one sensor device designed integrally with the joining tool is provided by energy storage devices such as batteries or accumulators. In this embodiment, advantageously no cable guides or devices for inductive energy transmission are required.

In one embodiment of the joining tool, the energy and/or data supply of at least one sensor device integrated with the joining tool is inductive. An induction coil can be used for the energy and/or data supply, which in particular extends over a sufficient stroke length of the joining tool. In this embodiment, cable guides for the energy and/or data supply can be advantageously omitted.

In one embodiment of the joining tool, the receiving device and the at least one integrated sensor device are arranged in front of a bearing of the joining tool in the direction of a connection axis. When the sensor device is arranged in front of a bearing of the joining tool, it is arranged in particular at a short distance or in the immediate vicinity of the screwing location. The process variables should be recorded as accurately as possible. For this reason, torque and force sensors in particular are best arranged in the immediate vicinity of the process-relevant point and therefore in front of a bearing point of the joining tool. As the proximity of the sensor device to the fastening location increases, the measurement result that can be recorded with the sensor device improves and therefore also the quality of the recording of a deviation of a joining process from the target process.

In one embodiment of the joining tool, the sensor device is arranged to record at least one process variable, which is selected from a group comprising the process variables rotational speed, torque, axial force, transverse force, bending load, vibration, acceleration and temperature. At least one reaction variable acting on the joining tool, such as the transverse force, the normal force and/or the torque, can be determined from the data of these process variables.

Further advantages, features and possible applications of the present invention are shown in the following description in conjunction with the figures.

It shows:

FIG. 1: a schematic representation of examples of incorrect positioning of joining elements compared with optimum positioning;

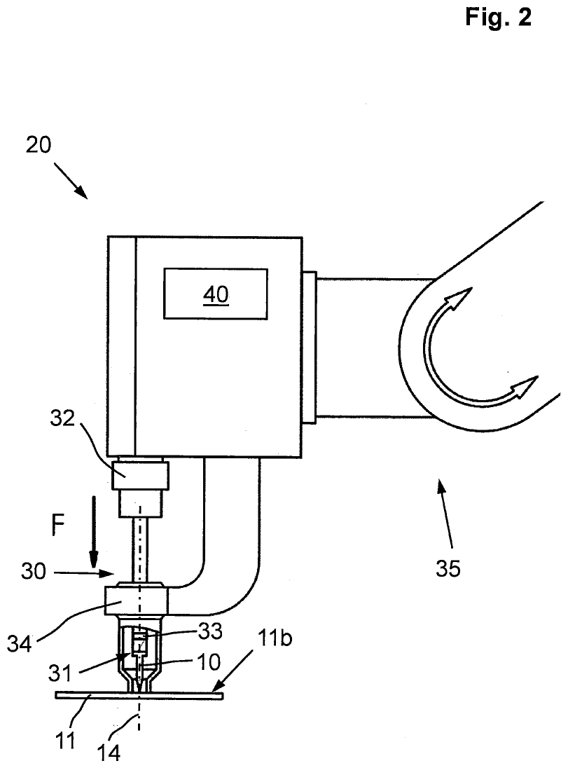

FIG. 2: an exemplary embodiment of a device according to the invention for introducing a joining element into at least one component;

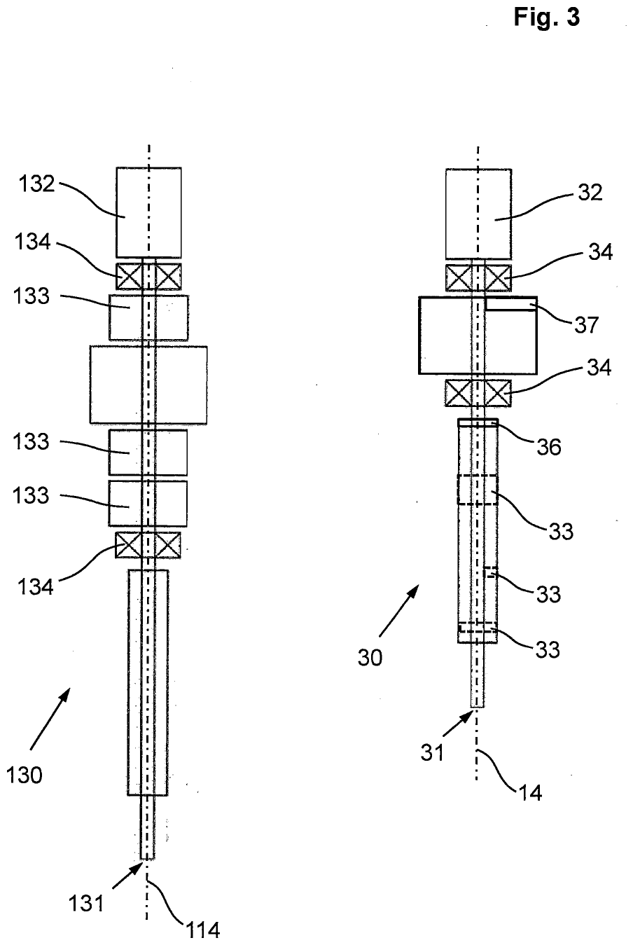

FIG. 3: an exemplary embodiment of a joining tool according to the invention for introducing a joining element into at least one component;

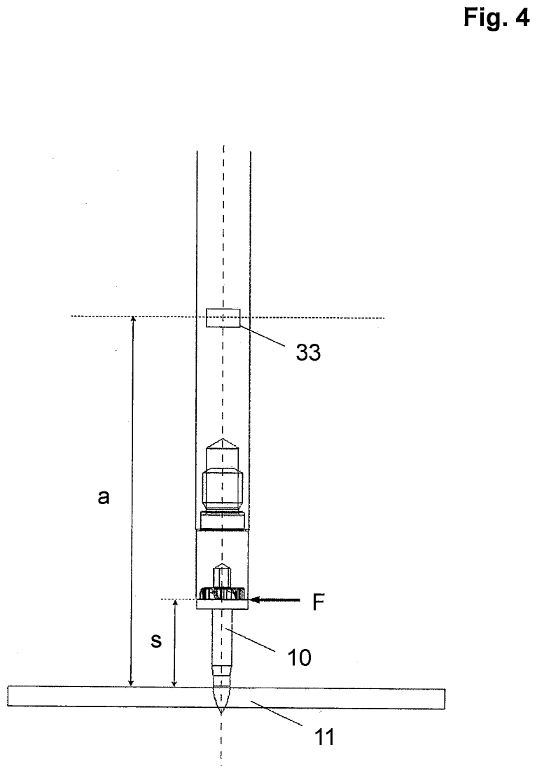

FIG. 4: a joining tool with integrated sensor element; and

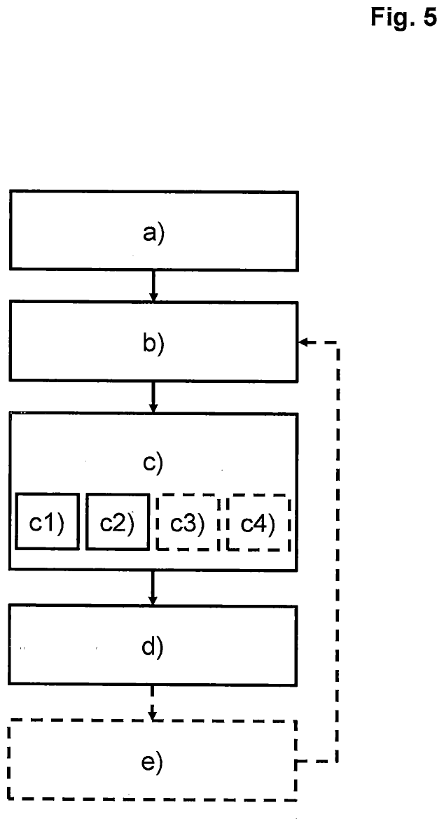

FIG. 5: a schematic representation of a flow diagram of an exemplary method according to the invention for introducing a joining element into at least one component.

FIG. 1 shows various situations when positioning joining elements 10 for introduction into a component 11. In the top row, a joining element 10 is shown from above during the introduction process into a component 11. The left-hand illustration shows ideal positioning, which can subsequently be joined without deviation and, in particular, without lateral force. The middle illustration shows an axial positioning error, which is typically caused by manufacturing tolerances of a pilot hole 12 of the component 11 or inaccurate positioning of the joining tool. In order to enable the joining element 10 to be introduced into the component 11 despite the axial positioning error, both joining elements 10 and the component 11 can be provided with chamfers 10a, 11a. This allows the joining element 10 to be introduced into the component 11 by the axial joining force F even if there is an offset a. If the position of the joining element 10 and thus the position of the force application is not corrected, an increased load or an increased load condition of the joining element 10 occurs when the joining element 10 is introduced into the component 11. The two illustrations on the far right show an angular offset error. The inclined joining axis 14′ has an angle @ to a component surface 11b and a corresponding angle a to the intended joining axis 14. The inclination of the joining tool 30 does not coincide with the component surface normal or, if a pilot hole 12 is present, with the bore axis. If the joining element 10 is nevertheless introduced into the component 11 in this situation, the joining axis 14 aligns with the axis of the pilot hole 12 during the introduction process. This leads to a bending load on the joining tool 30 and to abending load on the joining element 10, which is also reflected in a transverse load on the entire device 20.

FIG. 2 shows an exemplary embodiment of a device 20 according to the invention for introducing a joining element 12 into a component 11 along a joining axis 14 with a joining tool 30. The joining tool 30 is designed to guide the joining element 10 in the direction of the joining axis 14 and has a receiving device 31 for receiving the joining element 10 on the joining tool 30. Furthermore, the device 20 has a drive device 32 for guiding the joining element 10 into the component 11. A sensor device 33 for recording data of at least one process variable is arranged on the joining tool 10. The sensor device 33 is arranged to record at least one process variable, such as an axial force F applied by the joining tool 30, a torque applied by the joining tool 30 and/or the speed of rotation, or forces acting on the joining tool 30, such as the transverse force, the bending load, the acceleration or the temperature of the joining tool 30 at a predetermined position.

The exemplary device 20 shown in FIG. 2 also has a positioning device 35 for supporting and positioning the joining tool 30 and thus the joining element 10 on the component 11. The positioning device 35 can be used to position the joining tool 10 relative to the component 11 both in a plane perpendicular to the joining axis 11 and at an angle β to the surface 11b of the component 11 facing the joining element 10 in particular. The exemplary positioning device 35, in this case a multi-axis robot, is arranged to correct the positioning of the joining tool 10 relative to the component 11.

Furthermore, the device 20 has a machine control 40 for controlling the device 20. The machine control unit 40 is also arranged to determine a possible deviation from the target process with the aid of the data of the at least one process variable recorded by the at least one sensor device 33. In addition, the machine control unit 40 can be arranged to determine at least one reaction variable acting on the joining tool 30, such as the transverse force, the normal force and/or the torque, from the data of the at least one recorded process variable.

FIG. 3 shows on the right an exemplary embodiment of a joining tool 30 according to the invention for introducing a joining element 10 into at least one component 11. In the left-hand representation in FIG. 3, a joining tool 130 according to the state of the art is shown, on which several sensor devices 133 are arranged. A drive device 132 is used to drive the joining tool 130. The process variables should be recorded as accurately as possible, which is why sensor devices 133 on the joining tool 130 are also fitted as close as possible to the receiving device 131 of a joining element 10. As can be seen from the left-hand illustration in FIG. 3, this is not possible without difficulties, particularly with single size sensors 133. In addition, no bearings 134 can be provided in the installation space used for sensor devices 133, which results in larger distances and thus higher leverage effects. The size of the sensors 133 also has a direct influence on the overall length of the joining tool 130, which is particularly disadvantageous in robot-guided applications.

The right-hand illustration in FIG. 3 shows an exemplary joining tool 30 according to the invention for introducing a joining element 10 into at least one component 11 along a joining axis 14. The joining tool 30 has a receiving device 31 on which a joining element 10 can be received on the joining tool 30. In the exemplary joining tool 30 according to the invention, at least one sensor device 33 for recording data of at least one process variable that can be recorded on the joining tool 30 is integrated with the joining tool 30. The receiving device 31 and the at least one integrated sensor device 33 are arranged in front of a bearing 34 of the joining tool 30 in the direction of the joining axis 14. The joining tool 30 is also connected to a drive device 32.

The joining tool 30 also has an interface 36 for supplying power and/or data to the at least one sensor device 33 integrated with the joining tool 30, wherein the data transmission of at least one sensor device 33 designed integrally with the joining tool 30 can take place via a wireless connection.

The energy supply of at least one sensor device 33 designed integrally with the exemplary joining tool 30 according to the invention is provided by an energy store 37, whereby the energy and/or data supply of at least one sensor device 33 designed integrally with the joining tool 30 can also be provided inductively.

FIG. 4 shows a joining tool 30 with an integrated sensor device 33 in the form of a transverse force sensor 33a. A joining element 10, for example in the form of a flow-hole and thread-forming screw, is arranged on the receiving device 31 of the joining tool and is guided into a component 11 in the form of a sheet metal. An engagement element, for example in the form of a bit, is arranged on the receiving device 31 and is located in the engagement feature of the head of the joining element 10. While the joining tool 30 guides the joining element 10 into the component 11, the transverse force sensor 33 records the transverse force F acting on the joining tool 30. The recorded data of the transverse force F represent data of a process variable that characterize the load on the joining element 10 and are sent to a machine control.

In the embodiment example shown in FIG. 4, a transverse force F resulting from the introduction process acts at the connection point between the receiving device 31 and the head of the joining element 10, from which a load on the joining element 10 can be derived. The resulting transverse force F leads to a measurable bending load on the joining tool 30 and simultaneously to a bending load on the joining element 10. In the exemplary embodiment, the recorded transverse force F thus represents the process variable that characterizes the load on the joining element 10 and whose data is sent to the machine control.

The machine control unit uses this data to determine the load on the joining element 10. In the example, this is done taking into account the distance a of the transverse force sensor 33a and the distance s of the joining element 10 from the surface of the component 11 into which the joining element 11 is to be introduced. The transverse force sensor 33a was calibrated taking these distances into account. A load on the joining element 10 due to the transverse force F acting on the joining element 10 can thus be determined using at least one process variable recorded in the joining tool 30. With knowledge of the distances a and s, the bending load on the joining element during the joining process can also be calculated. In this way, a possible deviation of the load on the joining element 10 from a target load can be determined, in the exemplary embodiment in particular a target load defined by a transverse force or a bending load. In this way, an assessment of the joint quality can be carried out while the joining element 10 is being introduced into the component 11. In conjunction with storing the data of the at least one process variable recorded during introduction, it is also possible to evaluate the joint quality at a later point in time.

FIG. 5 shows a schematic representation of a flow diagram of an exemplary method according to the invention for introducing a joining element 10 into at least one component 11 along a joining axis 14 by means of a joining tool 30, which is designed to guide the joining element 10 in the direction of the joining axis 14. In a first step a), the joining element 10 is received at the joining tool 30. In a second step b), the joining tool 30 with the joining element 10 is positioned on the component 11 and guided into the component 11 in step c). In a sub-step c1), data of at least one process variable characterizing the load on the joining element 10 during its introduction into the component 11 is recorded on the joining tool 30 and sent to a machine control 40, whereby in a further sub-step c2), the machine control 40 uses the data obtained from the at least one process variable to determine a possible deviation of the load on the joining element 10 from a target load, so that a non-destructive evaluation of the joint quality during and after the introduction of the joining element 10 into the component 11 is possible. Once the joining element 10 has been introduced into the component 11, the joining tool 30 is released from the joining element 10 in step d). The data of the at least one process variable characterizing the load on the adjacent joining element 10 recorded at the joining tool 30 in step c1) are particularly suitable for determining the load on the joining element 10 due to a transverse force acting on it.

Optionally, in step c2), the machine control unit 40 can determine the possible deviation of the positioning of the joining tool 30 from a target positioning. Also optionally, in step c), a further sub-step c3) can be carried out, in which the machine control unit 40 derives at least one correction value for at least one process variable in the event of a specific deviation in the load on the joining element 10 and/or the positioning of the joining tool 30.

In a further optional sub-step c4), the at least one process variable is corrected using the at least one correction value derived in step c3) for this at least one process variable. In an embodiment of the device 20 in which the joining tool 30 can be positioned relative to the component 11 by means of a positioning device 35 both in a plane perpendicular to the joining axis 14 and at at least one angle β to a component surface 11b, the positioning of the joining tool 30 relative to the component 11 can be corrected on the basis of the at least one derived correction value.

In a further optional step e), the at least one correction value derived in step c3) is used for the positioning of the joining tool 30 during the execution of step b), the positioning of the joining tool 30 with the joining element 10 on the component 11 during a subsequent execution of the method for introducing a joining element 10.

1. Method for introducing a joining element (10) into at least one component (11) along a joining axis (14) by means of a joining tool (30, 130) which is designed to guide the joining element (10) in the direction of the joining axis (14), having the following steps:
a) Receiving the joining element (10) on the joining tool (30, 130);
b) Positioning the joining tool (30, 130) with the joining element (10) on the component (11);
c) Guiding the joining element (10) into the component (11), wherein
c1) on the joining tool (30, 130), data of at least one process variable characterizing the load of a joining element (10) guided into the component (11) are recorded and sent to a machine control (40);
c2) the machine control (40) determines a load on the joining element and, from this, a possible deviation of the load on the joining element from a target load with the aid of the data obtained for the at least one process variable, thereby enabling a non-destructive evaluation of the joint quality during and after the joining element (10) is guided into the component (11); and
d) Releasing the joining tool (30, 130) from the joining element (10) as soon as the joining element (10) has been introduced into the component (11).

2. Method for introducing a joining element (10) according to claim 1, characterized in that in step c2) the machine control (40) additionally determines the possible deviation of the positioning of the joining tool (30, 130) from a target positioning.

3. Method for introducing a joining element (10) according to one of the preceding claims, characterized by the further step:
c3) the machine control (40) derives at least one correction value for at least one process variable in the event of a specific deviation.

4. Method for introducing a joining element (10) according to claim 3, characterized by the further step:
c4) Correcting the at least one process variable using the at least one correction value derived in step c3) for the at least one process variable.

5. Method for introducing a joining element (10) according to claim 4, wherein the joining tool (30, 130) can be positioned relative to the component (11) by means of a positioning device (35) both in a plane perpendicular to the joining axis (14) and at at least one angle (β) to a component surface (11b), characterized in that the positioning device (35) in step c4) corrects the positioning of the joining tool (30, 130) relative to the component (11) on the basis of the at least one derived correction value.

6. Method for introducing a joining element (10) according to at least one of claims 3 to 5, characterized by the further step:
e) Using the at least one correction value derived in step c3) for the positioning of the joining tool (30, 130) during the execution of step b), the positioning of the joining tool (30, 130) with the joining element (10) on the component (11), during a subsequent execution of the method for introducing a joining element (10).

7. Method for introducing a joining element (10) according to at least one of the preceding claims, characterized in that the data of the at least one process variable recorded in step c1) on the joining tool (30, 130) are suitable for determining a transverse force acting on the joining tool (30, 130) and/or on the joining element (10).

8. Device (20) for introducing a joining element (10) into at least one component (11) along a joining axis (14), with a joining tool (30, 130) which is designed to guide the joining element (10) in the direction of the joining axis (14), with a receiving device (31, 131) on which the joining element (10) can be received on the joining tool (30, 130), and with a drive device (32, 132) for guiding the joining element (10) into the component (11), characterized by a sensor device (33, 133) arranged on the joining tool (30, 130) for recording data of at least one process variable characterizing the load of an adjacent joining element (10) and a machine control (40) which is arranged to determine a possible deviation from the target load of the joining element (10) with the aid of the recorded data of the at least one process variable.

9. Device for introducing a joining element (10) into at least one component (11) according to claim 8, characterized in that the machine control (40) is arranged to determine a possible deviation of the actual position of the joining tool (30, 130) from a target position with the aid of the recorded data of the at least one process variable.

10. Device for introducing a joining element (10) into at least one component (11) according to claim 9, characterized by a positioning device (35) for supporting and positioning the joining tool (30, 130) on the component (11), wherein the joining tool (30, 130) can be positioned by means of the positioning device (35) relative to the component (11) both in a plane perpendicular to the joining axis (14) and at an angle (B) to a component surface (11b).

11. Device for introducing a joining element (10) into at least one component (11) according to claim 10, characterized in that the positioning device (35) is arranged to correct the positioning of the joining tool (30, 130) relative to the component (11).

12. Device for introducing a joining element (10) into at least one component (11) according to at least one of claims 8 to 11, characterized in that the sensor device (33, 133) is arranged to record at least one process variable which is selected from a group comprising the process variables rotational speed, torque, axial force, transverse force, bending load, acceleration and temperature.

13. Device for introducing a joining element (10) into at least one component (11) according to at least one of claims 8 to 12, characterized in that the machine control (40) is arranged to determine at least one reaction variable acting on the joining tool (30), such as the transverse force, the normal force and/or the torque, from the data of the at least one recorded process variable.

14. Joining tool (30) for introducing a joining element (10) into at least one component (11) along a joining axis (14), which is designed to guide the joining element (10) in the direction of the joining axis (14), having a receiving device (31) on which the joining element (10) can be received on the joining tool (30), in particular for carrying out the method for introducing a joining element (10) into at least one component (11) according to at least one of claims 1 to 7, characterized in that at least one sensor device (33) for detecting data of at least one process variable which can be recorded on the joining tool (30) is designed integrally with the joining tool (30).

15. Joining tool according to claim 14, characterized in that the receiving device (31) and the at least one integrated sensor device (33) are arranged in the direction of a connecting axis (14) in front of a bearing (34) of the joining tool (30).
